(19) United States
(12) Patent Application Publication
(10) Pub. No.: US 2003/0214072 A1
(43) Pub. Date: Nov. 20, 2003

(54) Methods of molding a container

(75) Inventors: Andrew David Nurse, Loughborough (GB); Lee Edward Jan Styger, Burton on Trent (GB); Alastair McCourt, Huddersfield (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(73) Assignee: J. C. Bamford Excavators Limited, Uttoxeter (GB)

(21) Appl. No.: 10/426,307

(22) Filed: Apr. 30, 2003

(30) Foreign Application Priority Data
May 3, 2002 (GB) 0210177.2

(51) Int. Cl. B29C 41/04; B29C 41/20

(52) U.S. Cl. 264/259; 264/310; 264/275

(57) ABSTRACT

A method of molding a container by rotational molding in which molding material is introduced into a mold cavity, and the mold is rotated about at least one axis of rotation. Prior to introducing the molding material, a dividing member is located in the mold cavity to divide the mold cavity into at least two cavities. When the molding material is subsequently introduced and the mold rotated, molding material coats the member so that the member becomes an integral part of the container and provides first and second separated volumes within the container. In use, fluid contained in the first volume is maintained separate from fluid in the second volume.

### CROSS-REFERENCE TO RELATED APPLICATIONS

Priority is claimed to United Kingdom patent application Serial No. 0210177.2 filed May 3, 2002.

### STATEMENT REGARDING FEDERALLY SPONSORED RESEARCH OR DEVELOPMENT

Not Applicable.

### TECHNICAL FIELD

This invention related to method of molding a container. The invention had been particularly but not exclusively developed for molding a fluid container for a vehicle, such as a motor vehicle, or for a machine, such as an excavating and/or loading machine, but a container molded by the methods of the invention may be uses in multifarious other applications.

### BACKGROUND OF THE INVENTION

It is known to mold a container in a plastic material, using a rotational molding technique in which molding material is introduced into a mold cavity, and the mold is rotated about at least one axis of rotation. The molding material may be introduced into a mold cavity in the form of a powder which melts as it is introduced into a hot mold, or the powder is a mixture of chemicals which are introduced together or separately and chemically reacts to form a polymer. In each case the material coats the inside surface of the mold to form the container when the molding material solidifies. Alternatively, the molding material may be introduced into the mold cavity as a liquid, e.g., molten form, which then coats the inside surface of the mold to form the container when the molding material solidifies.

### BRIEF SUMMARY OF THE INVENTION

According to a first aspect of the invention we provide a method of molding a fluid container by rotational molding in which molding material is introduced into a mold cavity, and the mold is rotated about at least one axis of rotation wherein prior to introducing the molding material into the mold cavity a member is located in the mold cavity which divides the mold cavity. When the molding material is subsequently introduced and the mold rotated, molding material coats the member so that the member becomes an integral part of the molding and provides first and second separated volumes within the container. In use, fluid contained in the first volume is maintained separate from fluid in the second volume.

Thus using the method of the invention, the molded container may be provided with an internal wall which extends across the molded cavity to divide the molded container into the two separated volumes. In this way a container may be provided which in the first of the separated volumes a first fluid may be contained, and in the second of the separated volumes a second fluid may be contained, the internal wall preventing the two fluids from mixing in the container. In use, the first and second separated volumes may contain different fluids. For example, the molding material may be suitable for containing in one of the volumes at least one of lubricant fluid, hydraulic fluid and engine coolant fluid. The other volume may contain a fluid such as windscreen washer fluid so that in sub-zero environments, the windscreen washer fluid may be warmed by the warm hydraulic or engine coolant fluid. However, other vehicle or machine fluids, or fluids not particular to vehicles or machines, may be contained within the first and second separated volumes of the container.

In one embodiment of the method, molding material is alternately introduced into the mold cavity at opposite sides of the dividing member. The molding material may be introduced into the mold cavity at a first side of the dividing member, and the mold rotated to mold a first container part including coating one side of the dividing member, and subsequently molding material is introduced into the mold cavity at a second side of the dividing member and the mold rotated to mold a second container part including coating the second side of the dividing member whereby the container is molded to include the two separated volumes. Thus the two container parts are molded individually, the mold being rotated appropriately for molding each container part.

Conventionally, a mold for rotational molding has at least two mold parts which are brought together to form the mold cavity. The method of the invention may include locating the dividing member in the molding cavity by a plurality of locating elements which may for example pass through the walls of one or other of the mold parts. The dividing member which is located in the mold cavity may include a plurality of locating formations with which the locating elements co-operate to locate the dividing member in the mold cavity. The locating elements may be removed from co-operation with the coated dividing member subsequent to molding, prior to, subsequent to or during mold part separation to release the molded container.

According to a second aspect of the invention we provide a method of molding a container having at least two separated volumes including the steps of, prior to introducing molding material into a mold cavity, locating a dividing member in the mold cavity to divide the mold cavity, and then molding a first container part by introducing molding material into a first divided part of the mold cavity to mold a first container part which includes the first separated volume, removing the dividing member and then introducing molding material into a second divided part of the mold cavity to mold a second container part which provides the second separated volume, the second container part attaching to and becoming integral with the first container part.

The invention may be performed utilizing alternative molding methods to rotational molding, such as for example only, injection molding, and in the molded container, no dividing member may be retained between the first and second separated volumes, but an internal wall dividing the container into the first and second separated volumes may be provided by molding material only.

According to a third aspect of the invention we provide a method of molding a container having at least first and second separated volumes including molding a first container part by introducing molding material into a first mold cavity to form a first of the separated volumes, removing the molded first container part from the first mold cavity, placing the molded first container part into a second mold cavity introducing into the second mold cavity, exteriorly of the first molded container part, molding material so that a second container part attaches to and becomes integral with the first molded container part, the second container part providing the second separated volume. Thus a transfer molding method may be utilized to perform the invention.

In each of the second and third aspects of the invention, when molding the first container part, at least one attachment formation may be molded on the exterior of the first container part at a position where the second container part when subsequently molded is to attach to the first container part. The second container part is molded so that the attachment formation of the first container part may becomes embedded in molded material of the second container part. Thus a strong attachment of the first and container parts is achieved.

In each of the examples of methods of the invention, the molded container may be for containing two different fluids for a machine or a vehicle.

Various objects and advantages of the invention will become apparent from the following detailed description of the invention and the accompanying drawings.

### BRIEF DESCRIPTION OF THE DRAWINGS

FIG. 1 is a perspective illustrative view of a container molded by the method of the invention; and

FIG. 2 is a perspective illustrative view of an alternative container made by the method of the invention.

### DETAILED DESCRIPTION OF THE INVENTION

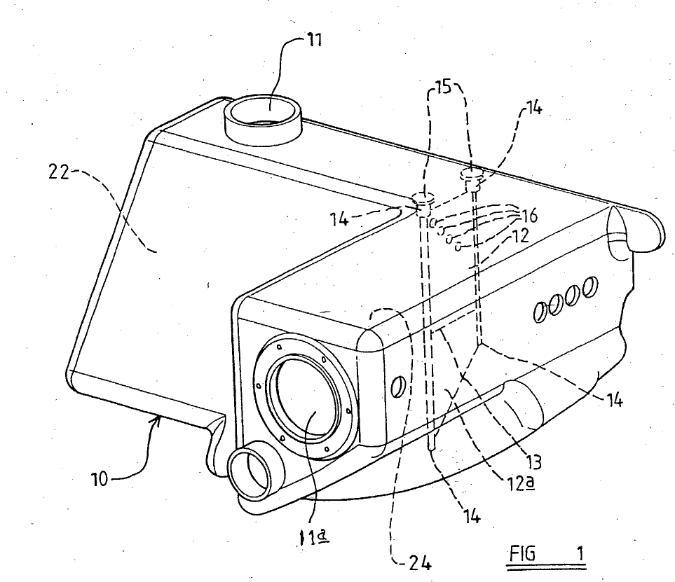

Referring to FIG. 1 of the drawings, a container 10 is made by molding a polymer using a rotational molding method which involves introducing molding material into a mold cavity of a mold, and rotating the mold about at least one axis of rotation.

In one method, the molding material may be introduced into a mold cavity in the form of a powder which melts as it introduced as the mold is hot, or the powder chemically reacts to form a polymer. In each case the material coats the inside surfaces of the mold cavity to form the container 10 when the molding material solidifies. Alternatively the molding material may be introduced into the mold cavity in a liquid, e.g., molten form. The liquid coats the inside surface of the mold to form the container 10 when the molding material solidifies.

The manner of rotating the mold may be determined to ensure generally even coating of the internal surface of the mold cavity depending on the configuration of the container 10. Conventionally, the mold cavity may be formed by a pair of mold parts which are separable after molding to permit the molded container 10 to be released from the mold.

It can be seen that the container 10 may be provided to a desired configuration to suit its application. For example where the container 10 is a tank for hydraulic fluid which has to fit in a given space in a machine or vehicle, the container may be molded to a configuration suitable to fit that space. The container 10 may be provided with any openings 11, 11a as desired for the container's function, usually subsequent to molding.

In accordance with the invention, the container 10 is molded with an internal wall 12. This is achieved by locating in the mold, a dividing member 12a, which may be made of metal, ceramics or any other suitable material. During molding, the dividing member 12a becomes coated with molding material. In this example the dividing member 12a includes formations 14 with which locating elements 15 co-operate to locate the dividing member 12a in position in the mold cavity. The locating elements 15 may be male threaded elements which may be screwed through the mold wall into co-operation with the locating formations 14 of the dividing member 12a. The elements 15 include axial hollows in which the locating formations 14 of the dividing member 12a are received as the elements 15 are screwed into the position shown in the drawing.

With the dividing member 12a in position when the molding material is introduced into the mold cavity, the member 12a becomes coated with the molding material and thus becomes an integral part of the molding to form the internal wall 12. The dividing member 12a extends substantially all the way across the mold cavity, so that the coated dividing member 12a separates the container 10 into first and second separated volumes 22 and 24. No exchange of fluid from one volume in one container part to the other volume in the other container part is permitted by the internal wall 12. Thus the container 10 is provided with a first volume in which in use, one fluid may be contained, and a second volume in which another fluid may be contained, the internal wall 12 preventing the fluids from mixing in the container 10 in use.

The container 10 may be used to store for example, an engine coolant fluid, or a lubricant fluid or a hydraulic fluid in one volume for examples, and a washer fluid, e.g. a windscreen washer fluid in the other volume for example only. In this case, particularly in sub-zero conditions, the washer fluid will be maintained warm by the warm engine coolant, lubricant or hydraulic fluid as the case may be, and this be protected from freezing. However the container 10 may be used to store other fluids in the respective first and second volumes 22, 24, which fluids may be for vehicle/machine use or otherwise. In each case, the dividing member 12a in this example becomes embedded in the molding material and an integral part of the container 10. Prior to, subsequent to, or even during separation of the mold parts to release the container 10 from the mold, the locating elements 15 may be withdrawn from any co-operation with the locating formations 14.

During molding, molding material may be introduced into the mold cavity at both sides of the dividing member 12a, either simultaneously or sequentially.

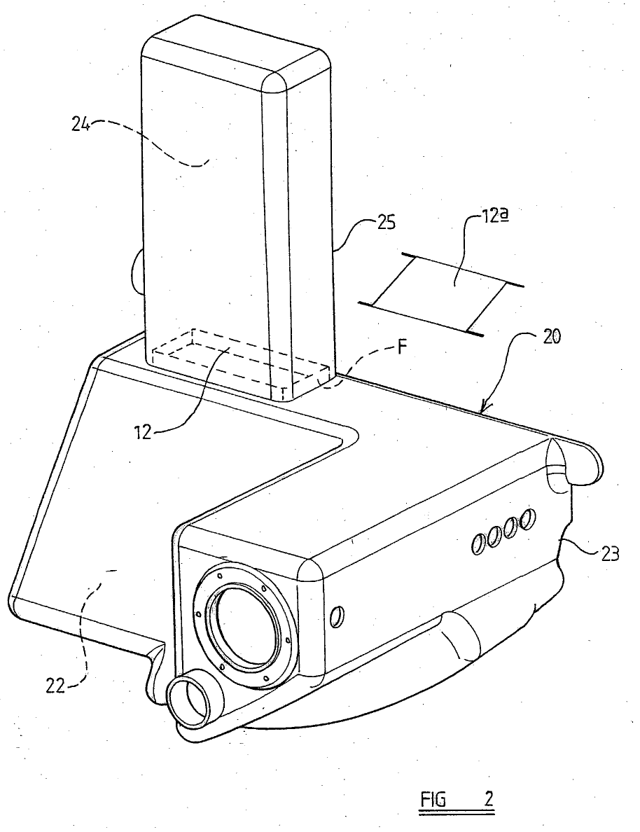

Referring to FIG. 2 another container 20 made by a molding method of the invention is shown. In this example the container 20 includes first 22 and second 24 separated volumes, in each volume 22, 24 of which a fluid may be contained. In one method, the container 20 may be made by a method substantially described with reference to FIG. 1 with a dividing member 12a becoming embedded in the molded material between the first and second separated volumes 22, 24 in respective molded parts 23, 25. However in a modified method, a dividing member 12a does not become embedded in molding material in the final container 20. Rather, when a first container part 23 for the first volume 22 has been molded, the dividing member 12a is removed from the mold cavity prior to a second container part 25 for the second volume 24 being molded, so that an internal wall 12 which divides the container 20 into first and second separated volumes 22, 24 is provided which is made entirely of molding material.

Where a rotational molding technique is used, it will be appreciated that the mold may be rotated during molding of the first container part 23 according to a first manner of rotation appropriate to ensure even coating of the internal surfaces of the mold cavity, for the particular configuration of the first container part 23, and the mold may be rotated during molding of the second container part 25 according to a second manner of rotation appropriate to ensure even coating of the internal surfaces of the mold cavity, for the particular configuration of the second container part 23.

Whereas rotational molding of the two container parts 23, 25 in a single molding cavity may be performed to mold the container 20, it will be appreciated that other molding methods may be employed to produce the container 20.

In one alternative example, instead of rotational molding, non-rotational, injection molding may be used, by injection molding the first container part 23 with a dividing member 12a located in the molding cavity, with the dividing member 12a being removed before (injection) molding the second container part 25.

In another method a transfer molding technique is used in which the first container part 23 may be molded in a first molding cavity, and the molded first container part 23 is then transferred to a larger second molding cavity into which molding material is introduced to attach to the exterior of the first container part 23, thus to form the second container part 25 which becomes integral with the first container part 23.

In each case where the second container part 25 is molded subsequent to the first container part 23, desirably, the first container part 23 is molded with at least one external outwardly extending attachment formation an example of which is shown at F in FIG. 2. The attachment formation F is provided by a ridge upstanding from the first container part 23. When the second container part 25 is subsequently molded, the ridge F becomes embedded in the material of the second container part 25 to facilitate and improve attachment of the second container part 25 to the first container part 23 so that the first and second container parts 23, 25 form a single, homogeneous molding with the first and second separated molded volumes 22, 24.

In the case of transfer molding it will be appreciated that no dividing member 12a is required when molding the first container part 23 to divide the mold cavity.

It will be appreciated that the first of the separated volumes may be larger or smaller than the second separated volume, such that the relative volumes may vary between 5% and 50% depending on what fluids are to be contained within the respective volumes. Particularly but not exclusively where one of the volumes contains windscreen washer fluid, within the molded volume in use, a submersible fluid pump may be located so that the washer or other fluid may be pumped from the separated volume 22 or 24.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. It will be appreciated that various modifications and changes may be made to the above described preferred embodiment of without departing from the scope of the following claims.

1. A method of molding a container for fluid by rotational molding in which molding material is introduced into a cavity of a mold, and the mold is rotated about at least one axis of rotation wherein prior to introducing the molding material, a member is located in the mold cavity which divides the mold cavity, so that when the molding material is subsequently introduced and the mold rotated, molding material coats the member so that the member becomes an integral part of the molding and provides first and second separated volumes within the container in each of which fluid in use is contained, the fluid contained in the first volume in use being maintained separate from the fluid in the second volume.

2. A method according to claim 1 and including the step of selecting the molding material from a material which is suitable for containing in one of the volumes at least one of lubricant fluid, hydraulic fluid and engine coolant fluid and in the other volume a fluid which is warmed by the warm lubricant, hydraulic or engine coolant fluid.

3. A method according to claim 1 wherein molding material is introduced into the mold cavity at both sides of the dividing member simultaneously.

4. A method according to claim 1 wherein the molding material is introduced into the mold cavity at a first side of the dividing member, and the mold rotated to mold a first container part including coating one side of the dividing member, and subsequently molding material is introduced into the mold cavity at a second side of the dividing member and the mold rotated to mold a second container part including coating the second side of the dividing member whereby the container is molded to include the two separated volumes.

5. A method according to claim 4 wherein the two container parts are molded individually, the mold being rotated appropriately for molding each container part.

6. A method according to claim 1 wherein the mold for rotational molding has at least two mold parts which are brought together to form the mold cavity.

7. A method according to claim 6 wherein the method includes locating the dividing member in the molding cavity by a plurality of locating elements which pass through the walls of one or other of the mold parts.

8. A method according to claim 7 wherein the dividing member includes a plurality of locating formations with which the locating elements co-operate to locate the dividing member in the mold cavity.

9. A method according to claim 7 wherein the locating elements are removed from co-operation with the coated dividing member subsequent to molding, prior to, subsequent to or during mold part separation to release the molded container.

10. A method of molding a container having at least two separated volumes including the steps of prior to introducing molding material into a mold cavity, locating a dividing member in the mold cavity to divide the mold cavity, and then molding a first container part by introducing molding material into a first divided part of the mold cavity to mold a first container part which includes a first separated volume, removing the dividing member and then introducing molding material into a second divided part of the mold cavity to mold a second container part which provides a second separated volume, the second container part attaching to and becoming integral with the first container part.

11. A method according to claim 10 wherein when molding the first container part, at least one attachment formation is molded on the exterior of the first container part at a position where the second container part when subsequently molded attaches to the first container part, and molding the second container part so that the attachment formation of the first container part becomes embedded in molded material of the second container part.

12. A method of molding a container having at least first and second separated volumes including molding a first container part by introducing molding material into a first mold cavity to form the first separated volume, removing the molded first container part from the first mold cavity, placing the molded first container part into a second mold cavity, introducing into the second mold cavity, exteriorly of the first molded container part, molding material so that a second container part attaches to and becomes integral with the first molded container part, the second container part providing the second separated volume.

13. A method according to claim 12 wherein when molding the first container part, at least one attachment formation is molded on the exterior of the first container part at a position where the second container part when subsequently molded is to attach to the first container part, and molding the second container part so that the attachment formation of the first container part becomes embedded in molded material of the second container part.
